(19) United States
(12) Patent Application Publication
(10) Pub. No.: US 2009/0182508 A1
(43) Pub. Date: Jul. 16, 2009

(54) Efficient Transmission of Electricity From a Wind Farm Located Remote From a Power Grid

(76) Inventors: Walter H. Serth, St. Louis, MO (US); Phillip C. Blahut, St. Louis, MO (US)

Correspondence Address: GRACE J FISHEL, 2200 WEST PORT PLAZA DRIVE, SUITE 202, ST. LOUIS, MO, 63146, US

(21) Appl. No.: 12/013,087

(22) Filed: Jan. 11, 2008

(51) Int. Cl. G06F 19/00; H02J 3/38

(52) U.S. Cl. 702/5; 307/69

(57) ABSTRACT

A method for the cost-effective transmission of electricity to a power grid capable of receiving it from a wind farm located remote from the power grid is provided wherein mapping information available for unused or abandoned pipelines, high voltage electrical transmission lines and average wind power locations is utilized to select sites where the building of a wind farm is not prohibited because of environmental and land use restrictions and which are situated near an unused or abandoned pipeline that intersects a power grid capable of receiving the energy produced by the wind farm. When a wind farm is built on a selected site, the energy may be efficiently transmitted to the power grid through an underground high voltage electric line installed in the pipeline.

### BACKGROUND OF THE INVENTION

1. Field of the Invention

The present invention relates to method for transmission of electricity to a power grid capable of receiving it from a wind farm located remote from the power grid.

2. Brief Description of the Prior Art

Large wind turbines are used primarily in arrays, called wind farms. Wind farms must be located where there are good wind resources because as an investment the wind farm must compete with conventional energy generation (coal, natural gas, oil and nuclear) at the wholesale level. Some of the land with good wind resources is unavailable for development because of environmental and land use restrictions. Much of the other land with good wind resources is located remote from a power grid with transmission capacity to receive it. In many cases at a remote location, the costs for making a grid connection which involves obtaining easements and building a high voltage electrical transmission line have been prohibitive.

### BRIEF SUMMARY OF THE INVENTION

In view of the above, it is an object of the present invention to provide a method for the efficient transmission of electricity from a wind farm located remote from a power grid. It is another object to provide a method which makes use of unused or abandoned oil or natural gas pipelines. It is also an object to provide a method which makes the selection of wind farm sites easier. Other objects and features of the invention will be in part apparent and in part pointed out hereinafter.

In accordance with the invention, a system for the cost-effective transmission of electricity to a power grid capable of receiving it from a wind farm located remote from the power grid is provided. The system makes use of mapping information available for unused or abandoned pipelines, high voltage electrical transmission lines and average wind power locations to select sites where the building of a wind farm is not prohibited because of environmental and land use restrictions and which are situated near an unused or abandoned pipeline that intersects a power grid capable of receiving the energy produced by the wind farm. When a wind farm is built on a selected site, the energy may be efficiently transmitted to the power grid through an underground high voltage electric line installed in the pipeline.

The invention summarized above comprises the methods hereinafter described, the scope of the invention being indicated by the subjoined claims.

### BRIEF DESCRIPTION OF THE SEVERAL VIEWS OF THE DRAWING

In the accompanying drawings, in which the method of the invention is illustrated, corresponding reference characters refer to corresponding elements throughout the several views of the drawings in which:

FIG. 1 is a map of an area under consideration for building a wind farm showing the average wind power for the location in accordance with the present invention;

FIG. 2 is a map of the area shown in FIG. 1 showing an unused or abandoned pipeline;

FIG. 3 is a map of the area shown in FIG. 1 showing a high voltage transmission line in a grid capable of receiving energy from a wind farm;

FIG. 4 is an overlay composite of the maps in FIGS. 1-3;

FIG. 5 is a map of the national power grid; and,

FIG. 6 is a map showing annual average wind power in the United States.

### DETAILED DESCRIPTION OF THE INVENTION

There are two general types of energy pipelines—oil pipelines and natural gas pipelines, some of which are unused or abandoned. In most instances an abandoned or unused pipeline is a negative asset as removal costs may not be recovered by the salvage value of the materials removed. For that reason or for reasons of national security, maps of existing abandoned or unused pipelines are not readily available but can be compiled from publicly available information including easements of record.

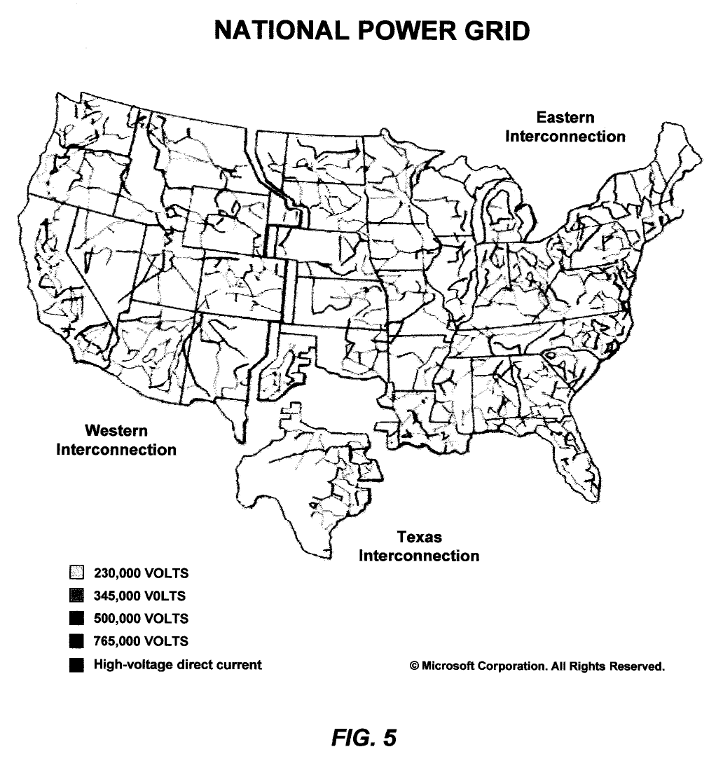

High voltage electrical transmission lines in the United States are divided into three separate grids that make up what is often called the national power grid. As shown in FIG. 5, maps of the national power grid are readily available. The three grids cover the contiguous 48 states and operate independently for the most part but are connected in a few places by direct-current lines.

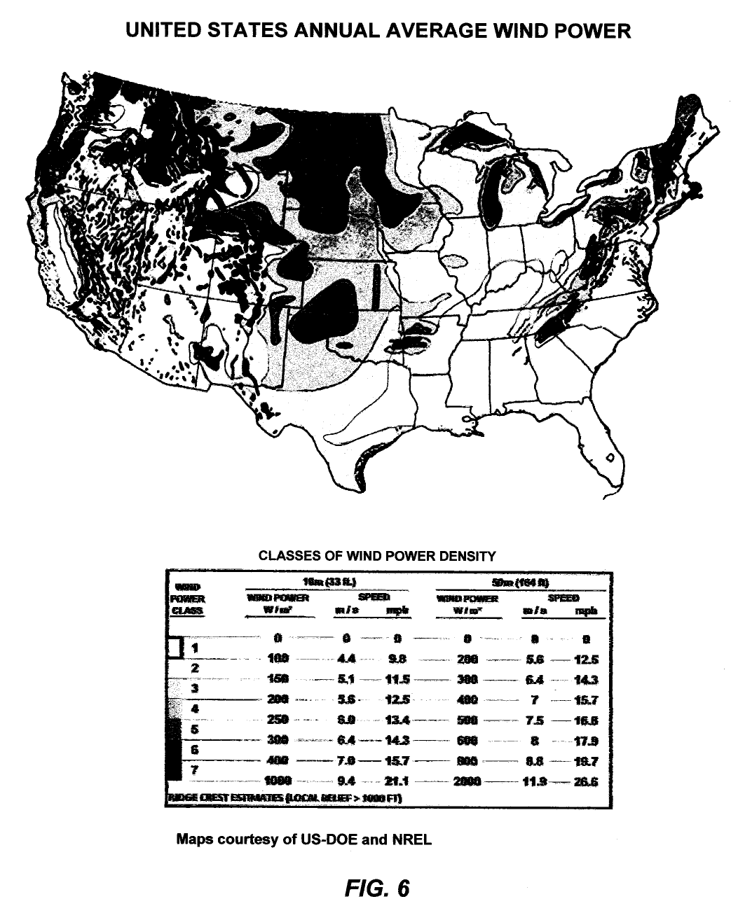

Maps of the United States showing annual average wind power are available from the US-DOE and NREL. As a general matter, wind energy potential increases rapidly with increasing wind speed. Calculations show that if wind speed doubles, the energy produced goes up by a factor of eight. Hence it is desirable to locate a wind farm in an area with high average wind power. As shown in FIG. 6, some desirable wind farm sites are located in populated areas where building of a wind farm would be prohibited because of environmental and land use restrictions. Many other sites which would be suitable for a wind farm are in remote areas which are miles from a power grid capable of receiving the energy produced by a wind farm.

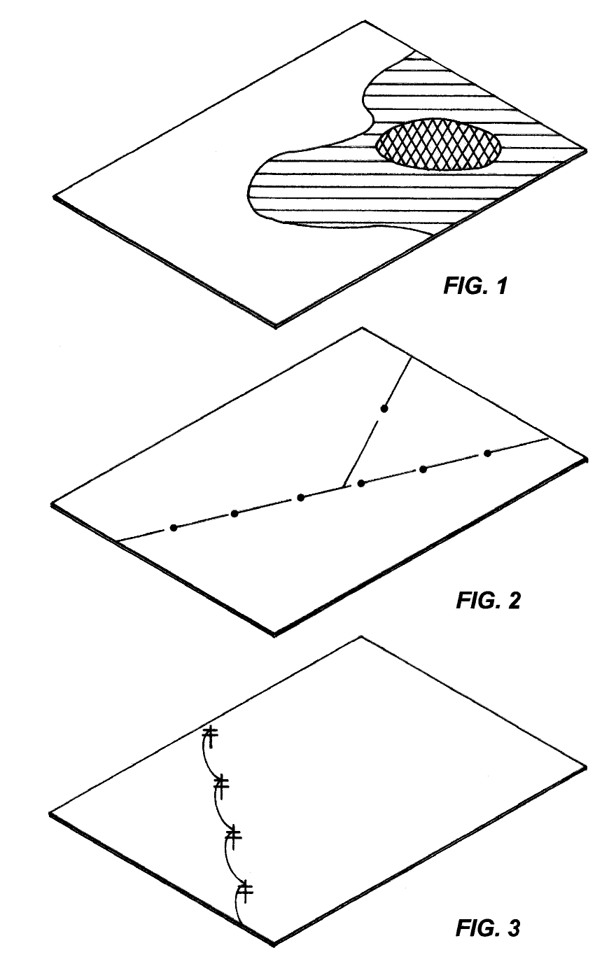

The present invention provides a method for the efficient transmission of electricity from a wind farm located remote from a power grid. Referring to the drawings more particularly by reference character, a map of an area being considered for building a wind farm (e.g., the United States) is consulted and locations of wind farm sites 10 where wind speeds are sufficient for competitively generating electricity and where the building of a wind farm is not prohibited because of environmental and land use restrictions are determined, one of which sites 10 is shown in FIG. 1.

For the area under consideration, as shown in FIG. 2, a map of unused or abandoned pipelines 12 is developed from publicly available information or from the owners of the pipeline rights. Finally for the area under consideration, a map of high voltage electrical transmission lines 14 is obtained as shown in FIG. 3.

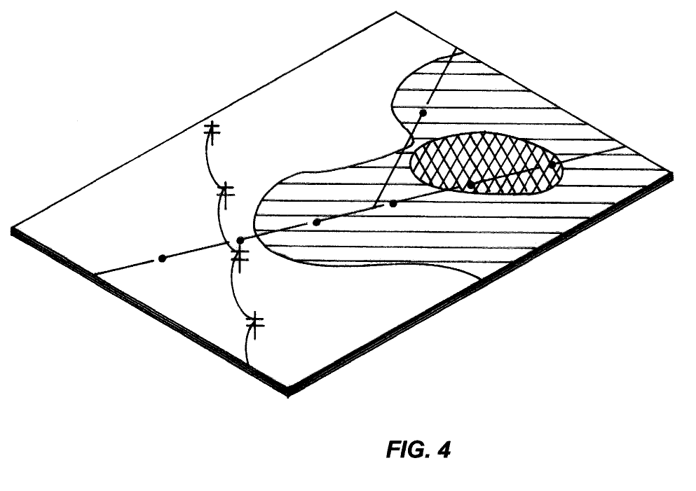

Prior to overlaying FIGS. 1-3 as shown in FIG. 4, the maps are converted, if necessary, to the same scale. A composite map such as shown in FIG. 4 is then inspected to identify a wind farm site 10 near a pipeline 12 that intersects 16 a high voltage electric transmission line 14 capable of receiving energy produced by a wind farm. It is desirable if unused or abandoned pipeline 12 either passes through wind farm site 10 or within a mile or two thereof. Whereas, the distance between the wind farm and intersection 16 of pipeline 12 with high voltage transmission line 14 is not so limited. However, a distance of ten miles or less may be preferred.

It will be understood that the selection of wind farm site 10 favorable to building a wind farm is not limited to the physical compositing, i.e., superimposing the maps one on another, of FIGS. 1-3 as illustrated. The information may be digitized and a computer programmed with an algorithm capable of performing the overlaying and examining of the overlaid maps to identify those wind farm sites 10 where wind speeds are sufficient for competitively generating electricity that are sufficiently near to a pipeline 12 that intersects 16 an electric transmission line 14 as likely candidates for building a wind farm. A report of possible sites may then be outputted for further consideration as to whether the necessary easements and permits can be obtained.

Once a favorable site 10 has been identified, the necessary rights from the land owners and permits from the government are obtained and a wind farm is built. An underground high voltage transmission line is installed in pipeline 12 for connecting the wind farm to the intersecting electrical transmission line 14. By making use of an unused or abandoned pipeline 12, the expense of building an above ground high voltage transmission line is avoided for which easements from the land owners and permits from government would need to be obtained. In addition, electrical transmission of energy underground is more efficient than transmission above ground because copper wires can be used whereas overhead cables normally cannot use copper because of its ductility.

In view of the above, it will be seen that the several objects of the invention are achieved and other advantageous results attained. As various changes could be made in the above methods without departing from the scope of the invention, it is intended that all matter contained in the above description or shown in the accompanying drawings shall be interpreted as illustrative and not in a limiting sense.

What is claimed:

1. A method for transmission of electricity from a wind farm located remote from a power grid, comprising:
determining the location of wind farm sites where wind speeds are sufficient for competitively generating electricity and where the building of a wind farm is not prohibited because of environmental and land use restrictions;
determining the location of unused or abandoned oil and natural gas pipelines;
determining the location of high voltage electrical transmission lines in a power grid capable of receiving energy produced by a wind farm;
identifying a wind farm site with sufficient wind speeds near which is a pipeline that intersects an electrical transmission line;
building a wind farm on the identified wind farm site; and,
installing an underground high voltage transmission line through the pipeline line to connect the wind farm to the power grid.

2. The method of claim 1 wherein identifying the wind farm site further comprises the steps of:
mapping the wind farm sites, pipelines and electrical transmission lines;
overlaying the maps of the wind farm sites, pipelines and electrical transmission lines; and
examining the overlaid maps.

3. The method of claim 1 wherein the distance between the selected wind farm site and the intersection between the pipeline and the high voltage transmission lines is ten miles or less.

4. The method of claim 2 wherein the mapping information regarding wind speeds, pipelines and electrical transmission lines is digitized and a computer is programmed with an algorithm for performing the overlaying of the maps and examining of the overlaid maps to identify those wind farm sites through which a pipeline passes that intersects an electric transmission line.
